(19) United States
(12) Patent Application Publication
(10) Pub. No.: US 2021/0303495 A1
(43) Pub. Date: Sep. 30, 2021

(54) SETTING ASSISTANCE DEVICE, SETTING ASSISTANCE METHOD, AND PROGRAM

(71) Applicant: Mitsubishi Electric Corporation, Tokyo (JP)

(72) Inventor: Hitoshi ICHIYANAGI, Tokyo (JP)

(73) Assignee: Mitsubishi Electric Corporation, Tokyo (JP)

(21) Appl. No.: 17/265,209

(22) PCT Filed: Sep. 13, 2018
(86) PCT No.: PCT/JP2018/033998

§ 371 Date: Feb. 2, 2021

(51) Int. Cl. G06F 13/362

(52) U.S. Cl. CPC G06F 13/362

(57) ABSTRACT

A setting assistance device (10) assists in connection setting between an input-output unit in a programmable logic controller and an input-output device connectable to the input-output unit. An input device (110) receives a user operation for selecting the input-output unit and the input-output device. A specification data acquirer (101) acquires first electrical specification data indicating electrical specifications of the input-output unit selected by the user through the input device (110). The specification data acquirer (101) acquires second electrical specification data indicating electrical specifications of the input-output device selected by the user through the input device (110). A determiner (102) determines, based on conformability between the electrical specifications indicated by the first electrical specification data and the electrical specifications indicated by the second electrical specification data, whether the input-output device is connectable to the input-output unit.

### TECHNICAL FIELD

The present disclosure relates to a setting assistance device, a setting assistance method, and a program.

### BACKGROUND ART

Programmable logic controllers include input-output units connectable to various input-output devices such as sensors and motors. However, connecting an input-output unit and an input-output device involves making various parameters, such as voltage, current, the number of points of a device, and response time, in conformity between the unit and the device. Thus, techniques are awaited for assisting in the connection setting between input-output units and input-output devices.

Patent Literature 1 describes a setting file generation assistance device that generates a setting file indicating the connection setting between input-output units and input-output devices. The setting file generation assistance device generates a setting file satisfying requirements for the number of points of a device. The setting file generation assistance device reduces manual checking for the parameter alignment for the number of the points, thus assisting in the connection setting between input-output units and input-output devices.

### CITATION LIST

### Patent Literature

Patent Literature 1: International Publication No. WO 2016/117079

### SUMMARY OF INVENTION

### Technical Problem

However, the setting file generation assistance device according to Patent Literature 1 generates a setting file without determining electrical specifications such as voltage and current. The electrical specifications of input-output units and input-output devices are to be checked manually to determine whether the connection setting indicated by the generated setting file satisfies such electrical specifications. Thus, the setting file generation assistance device according to Patent Literature 1 cannot sufficiently assist in the connection setting between input-output units and input-output devices.

An objective of the disclosure is to provide a setting assistance device that appropriately assists in the connection setting between input-output units in a programmable controller and input-output devices.

### Solution to Problem

To achieve the above objective, a setting assistance device according to an aspect of the present disclosure is a setting assistance device for assisting in connection setting between an input-output unit in a programmable logic controller and an input-output device connectable to the input-output unit. The setting assistance device includes input means for receiving a user operation for selecting the input-output unit and the input-output device for which the connection setting is to be made, specification data acquisition means for acquiring first electrical specification data indicating electrical specifications of the input-output unit selected by the user through the input means, and second electrical specification data indicating electrical specifications of the input-output device selected by the user through the input means, and determination means for determining whether the input-output device is connectable to the input-output unit based on conformability between the electrical specifications indicated by the first electrical specification data and the electrical specifications indicated by the second electrical specification data.

### Advantageous Effects of Invention

The setting assistance device according to the present disclosure determines whether an input-output device is connectable to an input-output unit based on electrical specification data, and appropriately assists in the connection setting between input-output units and input-output devices.

### BRIEF DESCRIPTION OF DRAWINGS

FIG. 1 is a functional block diagram of a setting assistance device according to Embodiment 1 of the present disclosure;

FIG. 2 is an example screen displayed by the setting assistance device according to Embodiment 1 of the present disclosure;

FIG. 3 is an example input-output unit table stored in a storage in the setting assistance device according to Embodiment 1 of the present disclosure;

FIG. 4 is an example input-output device table stored in the storage in the setting assistance device according to Embodiment 1 of the present disclosure;

FIG. 5 is an example hardware configuration diagram of the setting assistance device according to Embodiment 1 of the present disclosure;

FIG. 6 is a flowchart showing an example operation of connectivity determination performed by the setting assistance device according to Embodiment 1 of the present disclosure;

FIG. 7 is a flowchart showing an example operation of conformity determination for electrical specifications performed by a determiner in the setting assistance device according to Embodiment 1 of the present disclosure;

FIG. 8 is a functional block diagram of a setting assistance device according to Embodiment 2 of the present disclosure;

FIG. 9 is a diagram showing an example relationship between the ambient temperature, the input voltage, and the number of usable points of an input unit;

FIG. 10 is an example screen displayed by the setting assistance device according to Embodiment 2 of the present disclosure;

FIG. 11 is an example input-output unit table stored in a storage in the setting assistance device according to Embodiment 2 of the present disclosure;

FIG. 12 is an example input-output device table stored in the storage in the setting assistance device according to Embodiment 2 of the present disclosure;

FIG. 13 is a flowchart showing an example operation of connectivity determination performed by the setting assistance device according to Embodiment 2 of the present disclosure;

FIG. 14 is a functional block diagram of a setting assistance device according to Embodiment 3 of the present disclosure;

FIG. 15 is a ladder diagram showing an example program executed by a programmable logic controller;

FIG. 16 is an example screen displayed by the setting assistance device according to Embodiment 3 of the present disclosure;

FIG. 17 is an example input-output device table stored in a storage in the setting assistance device according to Embodiment 3 of the present disclosure;

FIG. 18 is a flowchart showing an example operation of conformity determination for operating speeds performed by the setting assistance device according to Embodiment 3 of the present disclosure;

FIG. 19 is a flowchart showing an example operation of conformity determination for operating speed specifications performed by a determiner in the setting assistance device according to Embodiment 3 of the present disclosure;

FIG. 20 is a functional block diagram of a setting assistance device according to Embodiment 4 of the present disclosure;

FIG. 21 is an example screen displayed by the setting assistance device according to Embodiment 4 of the present disclosure; and

FIG. 22 is a flowchart showing an example operation of updating data performed by a data server communicating with the setting assistance device according to Embodiment 4 of the present disclosure.

### DESCRIPTION OF EMBODIMENTS

Setting assistance devices according to embodiments of the present disclosure will now be described with reference to the drawings. The same or equivalent components are given the same reference numerals throughout the drawings.

Embodiment 1

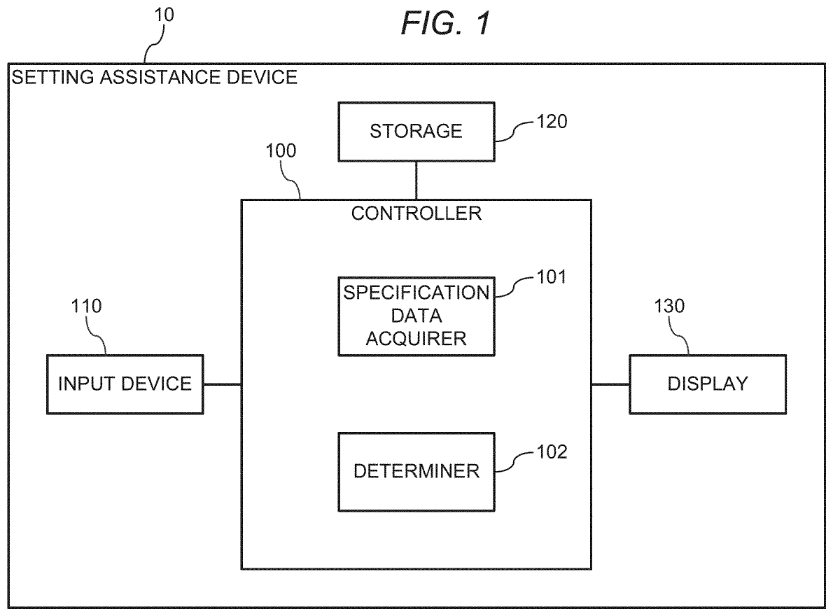

A setting assistance device 10 according to Embodiment 1 will now be described with reference to FIG. 1. The setting assistance device 10 includes a controller 100 that controls functional units, an input device 110 that receives an input operation from the user, a storage 120 that stores data, and a display 130 that performs screen display. The setting assistance device 10 is an example of a setting assistance device according to the present disclosure.

An overview of the setting assistance device 10 will now be provided. In connection setting between input-output units in a programmable logic controller (hereafter, PLC) and input-output devices to be connected to the input-output units, the setting assistance device 10 determines whether an input-output unit is connectable to an input-output device by determining whether the electrical specifications of the input-output unit conform to the electrical specifications of the input-output device. The connection setting refers to the setting for the correspondence between an input-output device and an input-output unit to be connected to each other. The electrical specifications refer to the electrical connection specifications to be considered in connecting an input-output unit to an input-output device. Examples of the electrical specifications include the rated input voltage and the maximum output current. When a comparison between the electrical specifications of an input-output unit and the electrical specifications of an input-output device reveals that connecting the input-output unit to the input-output device has no potential electrical failures, the electrical specifications of the input-output unit conform to the electrical specifications of the input-output device.

The input-output units include both an input unit and an output unit. The input-output devices include both an input device and an output device. An input unit receives signals output from an output device. An output unit outputs and feeds signals to an input device. An output device outputs and feeds signals to an input unit. An input device receives signals output from an output unit and feeds the signals to a circuit in the device. An output device is, for example, a sensor. An input device is, for example, a motor. An input unit and an output unit are examples of the input-output units according to the present disclosure. An input device and an output device are examples of the input-output devices according to the present disclosure.

The setting assistance device 10 is implemented by, for example, a computer such as a personal computer or a smartphone executing an engineering tool program installed on the computer. The engineering tool is a tool for setting the configuration of PLC units and input-output devices on a computer. The engineering tool allows the connection setting between input-output units and input-output devices.

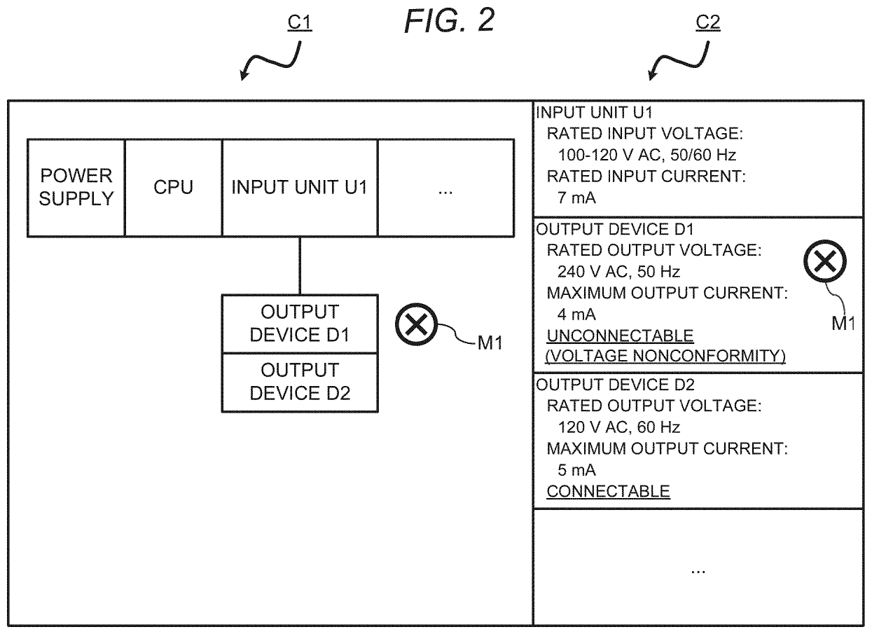

An example screen displayed on the display 130 in the setting assistance device 10 will now be described with reference to FIG. 2. The screen shown in FIG. 2 is a graphical user interface (GUI) of the setting assistance device 10. The user may provide an input to the input device 110 to operate the setting assistance device 10 on the GUI.

The screen shown in FIG. 2 includes a configuration display area C1 and a data display area C2. The configuration display area C1 is used for displaying the configuration of PLC units and input-output devices. The user may set the configuration of the PLC units and the input-output devices by performing operations on the configuration display area C1. In particular, the user may perform the connection setting between the input-output unit and the input-output device by performing an operation on the screen for connecting an input-output unit and an input-output device. This operation corresponds to an operation for selecting an input-output unit and an input-output device for which the connection setting is made.

In the example in FIG. 2, a PLC includes units such as a power supply, a central processing unit (CPU), and an input unit U1, with the input unit U1 connected to an output device D1 and an output device D2. In the example in FIG. 2, an error mark M1 is also displayed near the field of the output device Dl. The displayed error mark M1 indicates that the output device D1 is unconnectable to the input unit U1.

The data display area C2 displays, for example, the rated input voltage and the rated input current of an input-output unit, the rated output voltage and the maximum output current of an input-output device, and information indicating whether the input-output device is connectable. In the example in FIG. 2, the output device D1 is unconnectable to the input unit U1 due to nonconformity in voltage. The error mark M1 displayed in the area for displaying information about the output device D1 also indicates that the output device D1 is unconnectable to the input unit U1.

In the example in FIG. 2, the input unit U1 is an input-output unit, and output devices are input-output devices. In examples other than shown in FIG. 2, the PLC configuration may include an output unit, and an input device may be connected to the output unit. In this case, the output unit is an input-output unit, and the input device is an input-output device.

The above provides the overview of the setting assistance device 10. The functional structure of the setting assistance device 10 will now be described with reference back to FIG. 1.

The input device 110 receives an input operation from the user. More specifically, the input device 110 receives a user operation for selecting an input-output unit and an input-output device for which the connection setting is to be made. The input device 110 outputs input information about input by the user to the controller 100. The functions of the input device 110 are implemented by an input device such as a keyboard, a mouse, or a touch panel integral with the display 130. The input device 110 is an example of input means according to the present disclosure.

The display 130 displays, for example, the screen shown in FIG. 2 under control by the controller 100. More specifically, the display 130 displays the results of determination as to whether the input-output device is connectable to the input-output unit to notify the user of the determination results. The display 130 is implemented by a display device such as a liquid crystal display or an organic electroluminescence (OEL) display.

The controller 100 includes a specification data acquirer 101 that acquires specification data about an input-output unit and an input-output device from the storage 120, and a determiner 102 that determines whether the input-output device is connectable to the input-output unit. The controller 100 selects, in accordance with input information acquired from the input device 110, an input-output unit and an input-output device for which the connection setting is to be made. For example, when the user performs an operation for connecting the input unit U1 and the output device D1 on the configuration display area C1 shown in FIG. 2, the controller 100 selects the input unit U1 as an input-output unit for which the connection setting is to be made and the output device D1 as an input-output device for which the connection setting is to be made.

The specification data acquirer 101 in the controller 100 acquires, from an input-output unit table stored in the storage 120, first electrical specification data indicating the electrical specifications of the input-output unit for which the connection setting is to be made. The specification data acquirer 101 acquires, from an input-output device table stored in the storage 120, second electrical specification data indicating the electrical specifications of the input-output device for which the connection setting is to be made. The input-output unit table, the input-output device table, and the electrical specifications will be described in detail later. The specification data acquirer 101 is an example of specification data acquisition means according to the present disclosure.

The first electrical specification data includes first voltage specification data indicating the connection specifications about the voltage of the input-output unit and first current specification data indicating the connection specifications about the current of the input-output unit. The second electrical specification data includes second voltage specification data indicating a connection specification about the voltage of the input-output device and second current specification data indicating a connection specification about the current of the input-output device. The connection specifications about voltage and the connection specifications about current will be described in detail later.

The determiner 102 in the controller 100 determines whether the input-output device is connectable to the input-output unit based on the conformability between the specifications indicated by the first electrical specification data and the specifications indicated by the second electrical specification data acquired by the specification data acquirer 101. More specifically, the determiner 102 determines whether the voltage specification included in the first voltage specification data conforms to the voltage specification included in the second voltage specification data, and whether the current specification included in the first current specification data conforms to the current specification included in the second current specification data. In accordance with the determination results, the determiner 102 determines whether the input-output device is connectable to the input-output unit. The determinations will be described in detail later. The determiner 102 is an example of determination means according to the present disclosure.

The controller 100 displays the results of the determination performed by the determiner 102 on the display 130 to notify the user of the determination results. For example, the controller 100, as shown in FIG. 2, displays the error mark M1 near the field of the input-output device determined to be unconnectable, notifying the user of the determination that the input-output device is unconnectable. The controller 100 also displays the input-output device and the electrical specifications of the input-output device on the display 130, as shown in FIG. 2.

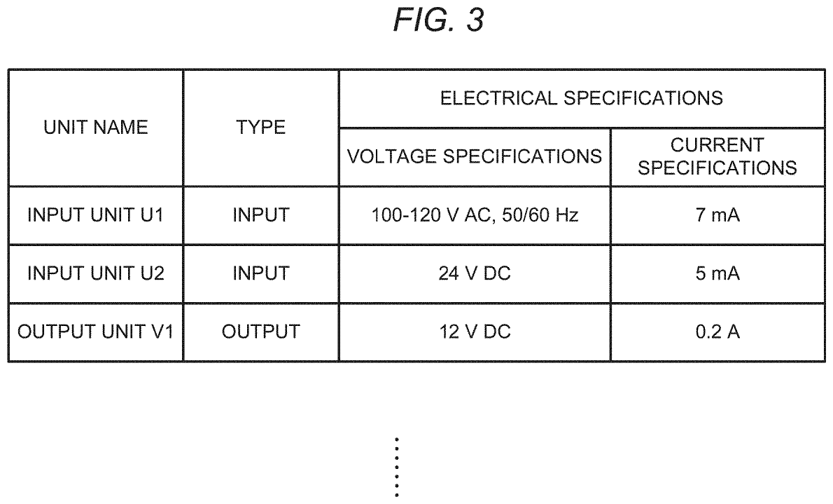

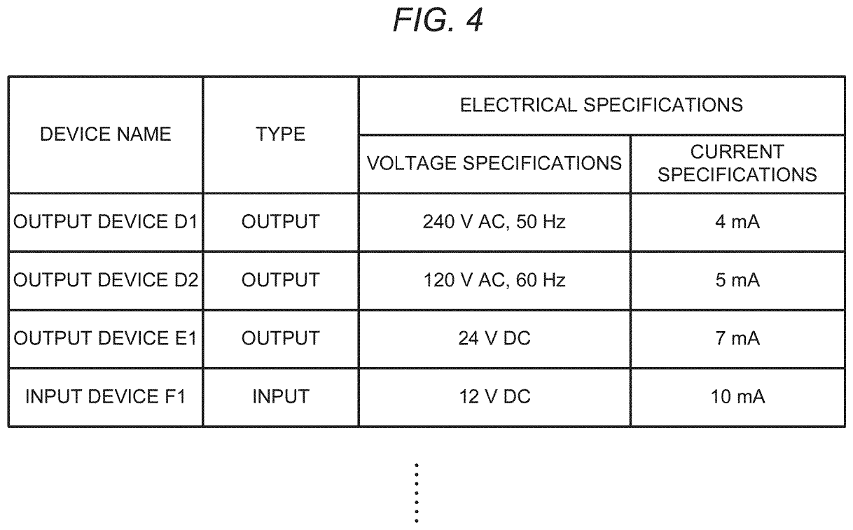

The storage 120 stores the input-output unit table and the input-output device table. As shown in FIG. 3, the input-output unit table includes a unit name, a type, and electrical specifications in an associated manner. As shown in FIG. 4, the input-output device table similarly includes a device name, a type, and electrical specifications in an associated manner. The type indicates whether each input-output unit is an input unit or an output unit, or whether each input-output device is an input device or an output device. The type is Input for an input-output unit that is an input unit and an input-output device that is an input device. The type is Output for an input-output unit that is an output unit and an input-output device that is an output device.

As described above, the electrical specifications refer to the electrical connection specifications to be considered in connecting an input-output unit to an input-output device, such as the rated input voltage and the maximum output current. The electrical specifications include voltage specifications and current specifications. The voltage specifications are the connection specifications about voltage. For the type Input, the voltage specifications correspond to the rated input voltage. For the type Output, the voltage specifications correspond to the rated output voltage. The current specifications are the connection specifications about current. For the type Input, the current specifications correspond to the rated input current. For the type Output, the current specifications correspond to the maximum output current.

The specification data acquirer 101 acquires data representing the electrical specifications included in the input-output unit table as the first electrical specification data. In particular, the specification data acquirer 101 acquires data representing the voltage specifications as the first voltage specification data, and the data representing the current specifications as the first current specification data. Similarly, the specification data acquirer 101 acquires data representing the electrical specifications included in the input-output device table as the second electrical specification data. In particular, the specification data acquirer 101 acquires data representing the voltage specifications as the second voltage specification data, and the data representing the current specifications as the second current specification data.

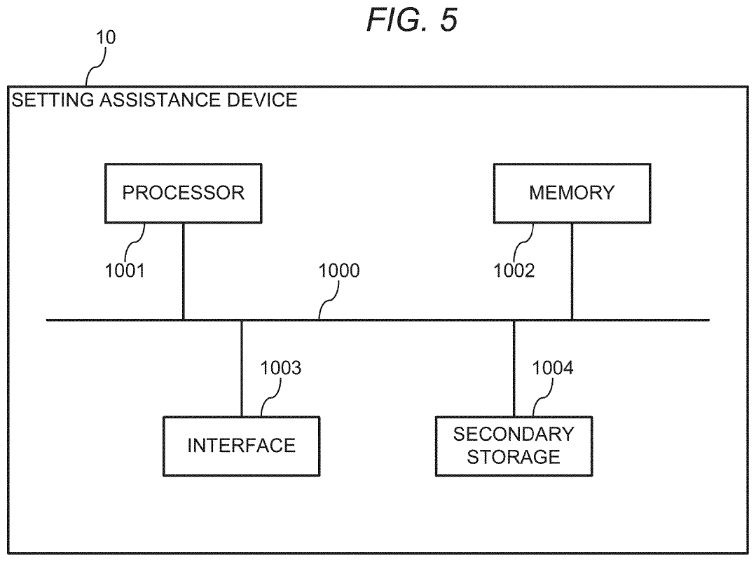

The above describes the functional structure of the setting assistance device 10. An example of the hardware configuration of the setting assistance device 10 will now be described with reference to FIG. 5. The setting assistance device 10 shown in FIG. 5 is implemented by, as described above, a computer such as a personal computer or a smartphone.

The setting assistance device 10 includes a processor 1001, a memory 1002, an interface 1003, and a secondary storage 1004 connected to each other with a bus 1000.

The processor 1001 is, for example, a CPU. When the processor 1001 reads a control program stored in the secondary storage 1004 into the memory 1002 and executes the program, each function of the setting assistance device 10 is implemented. The control program is, for example, the above engineering tool program.

The memory 1002 is, for example, a main memory that is a random-access memory (RAM). The memory 1002 stores a dedicated program read by the processor 1001 from the secondary storage 1004. The memory 1002 also functions as a working memory when the processor 1001 executes the dedicated program.

The interface 1003 is, for example, an input-output (I-O) port such as a serial port or a universal serial bus (USB) port. An input device such as a keyboard, a mouse, or a touch panel connected to the interface 1003 implements the function of the input device 110. A display device such as a liquid crystal display or an OEL display connected to the interface 1003 implements the function of the display 130.

The secondary storage 1004 is, for example, a flash memory, a hard disk drive (HDD), or a solid-state drive (SSD). The secondary storage 1004 stores the dedicated program executed by the processor 1001. The secondary storage 1004 also implements the function of the storage 120.

Setting assistance devices 10A to 10C (described later) according to Embodiments 2 to 4 may have the same hardware configuration.

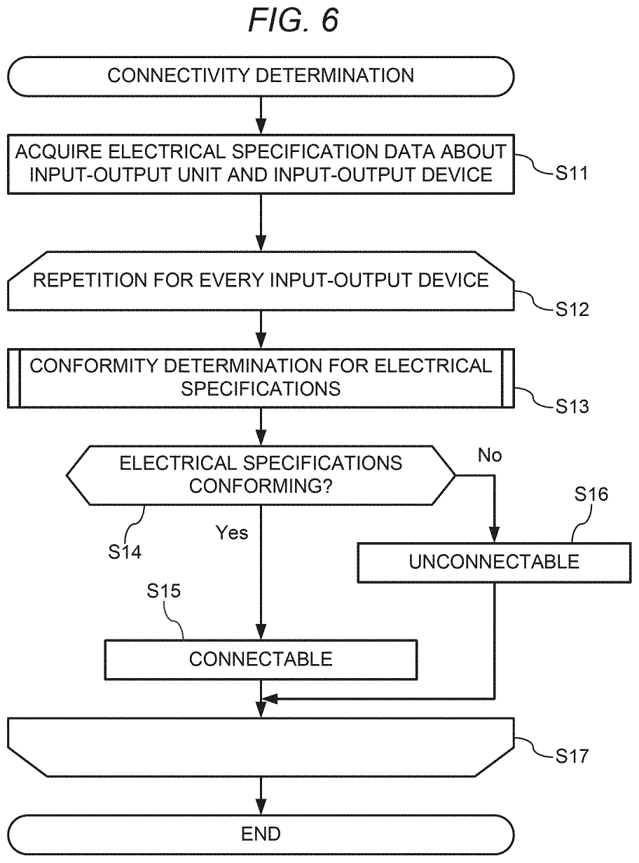

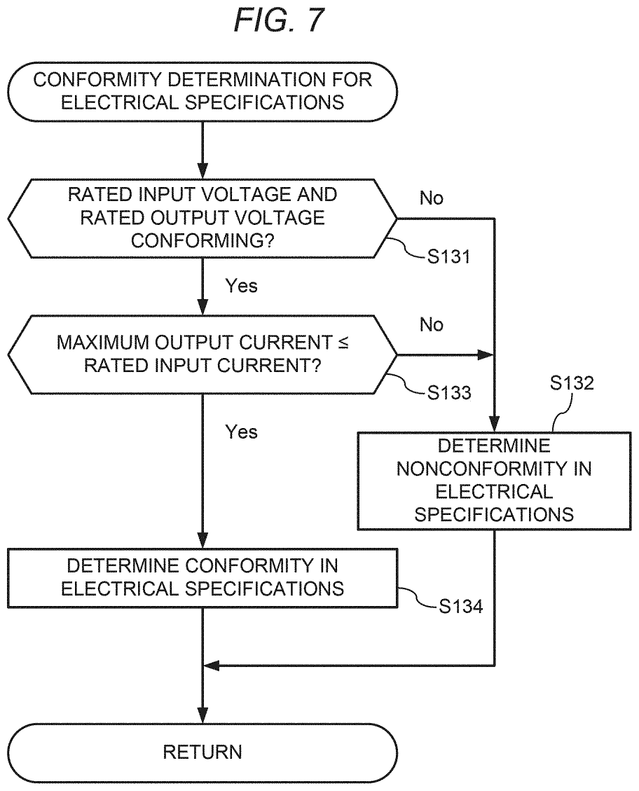

The above describes the configuration of the setting assistance device 10. An example operation of the connectivity determination performed by the setting assistance device 10 will now be described with reference to FIGS. 6 and 7. The connectivity determination determines whether an input-output unit is connectable to an input-output device. The operation shown in FIG. 6 is executed when, for example, the user performs connection setting between an input-output unit and each input-output device, followed by the operation of an instruction to execute the connectivity determination. In some embodiments, the determination may be executed automatically when the user performs connection setting between an input-output unit and an input-output device. In the operation shown in FIG. 6, the single input-output unit is a target for the connectivity determination. However, a plurality of input-output units may be targets for connectivity determination by executing the operation shown in FIG. 6 for each input-output unit.

In the example described below, the screen on the display 130 is shown in FIG. 2. In the specific example, the operation of the controller 100 about screen display will be described.

The specification data acquirer 101 in the controller 100 acquires the electrical specification data about an input-output unit and an input-output device for which the connection setting is made (step S11). More specifically, the specification data acquirer 101 acquires the first electrical specification data indicating the electrical specifications of the input-output unit and the second electrical specification data indicating the electrical specifications of the input-output device. With a plurality of input-output devices for which the connection setting is to be made, the specification data acquirer 101 will acquire the electrical specification data about all the input-output devices.

As described above, the first electrical specification data includes the first voltage specification data and the first current specification data, and the second electrical specification data includes the second voltage specification data and the second current specification data.

In the example in FIG. 2, the specification data acquirer 101 acquires the electrical specification data about the input unit U1, the electrical specification data about the output device D1, and the electrical specification data about the output device D2. In response to the electrical specification data acquired by the specification data acquirer 101, the controller 100 displays the electrical specifications included in the electrical specification data on the screen.

The controller 100 repeats the operation of steps S12 to S17 for each input-output device for which the connection setting is to be made. More specifically, the controller 100 selects one input-output device and performs the operation of steps S12 to S17, and repeats the process until completing the operation for every input-output device.

In the example in FIG. 2, the controller 100 performs the operation of steps S12 to S17 for the output device D1 and the output device D2.

The determiner 102 in the controller 100 determines whether the electrical specifications of the input-output unit conform to the electrical specifications of the selected input-output device (step S13). The conformity determination for electrical specifications will be described in detail later.

In the example in FIG. 2, the determiner 102 determines the nonconformity between the electrical specifications of the input unit U1 and the electrical specifications of the output device D1, and the conformity between the electrical specifications of the input unit U1 and the electrical specifications of the output device D2.

When determining the conformity in the electrical specifications (Yes in step S14), the determiner 102 determines the selected input-output device to be connectable to the input-output unit (step S15). When determining the nonconformity in the electrical specifications (No in step S14), the determiner 102 determines the selected input-output device to be unconnectable to the input-output unit (step S16).

In the example in FIG. 2, the determiner 102 determines the output device D1 to be unconnectable to the input unit U1, and the output device D2 to be connectable to the input unit U1. In response to the connectivity determination performed by the determiner 102, the controller 100 causes the screen to indicate that the output device D1 is unconnectable but the output device D2 is connectable. The controller 100 also causes the screen to indicate that the output device D1 has been determined to be unconnectable due to the nonconformity in the voltage specifications.

After the operation of steps S12 to S17 is performed for every input-output device, the controller 100 ends the operation of connectivity determination.

The operation of conformity determination for electrical specifications in step S13 will now be described with reference to FIG. 7. The determiner 102 first compares the first voltage specification data included in the first electrical specification data with the second voltage specification data included in the second electrical specification data to determine whether the rated input voltage conforms to the rated output voltage (step S131).

The determination will be described in more detail for the input-output unit that is an input unit and the input-output device that is an output device. In this example, the first voltage specifications indicate the rated input voltage of the input unit, and the second voltage specifications indicate the rated output voltage of the output device. The determiner 102 determines whether the rated input voltage conforms to the rated output voltage.

For the rated input voltage that is alternating voltage, and the rated output voltage that is direct voltage, the determiner 102 determines the nonconformity between the rated input voltage and the rated output voltage. Similarly, for the rated input voltage that is direct voltage, and the rated output voltage that is alternating voltage, the determiner 102 determines the nonconformity between the rated input voltage and the rated output voltage.

For both the rated input voltage and the rated output voltage that are alternating voltage, Rated Input Voltage and Rated Output Voltage indicate frequencies. When the frequency indicated by Rated Output Voltage does not conform to the frequency indicated by Rated Input Voltage, the determiner 102 determines the nonconformity between the rated input voltage and the rated output voltage.

When the voltage value indicated by Rated Output Voltage does not conform to the voltage value indicated by Rated Input Voltage, the determiner 102 determines the nonconformity between the rated input voltage and the rated output voltage. In some embodiments, the voltage value may be a single value. In some embodiments, the voltage value may be represented as a range indicated by a set of the lowest and the highest values. For example, when the voltage value indicated by Rated Input Voltage ranges from 100 to 120 V, and the voltage value indicated by Rated Output Voltage is 110 V (specifically, the voltage value of 110 V in Rated Output Voltage falls within the voltage values of 100 to 120 V in Rated Input Voltage), nonconformity is not determined.

When nonconformity is determined in none of the above examples, the determiner 102 determines the conformity between the rated input voltage and the rated output voltage.

When determining the nonconformity between the rated input voltage and the rated output voltage (No in step S131), the determiner 102 determines the nonconformity in electrical specifications between the input-output unit and the input-output device (step S132), and ends the operation of conformity determination for electrical specifications.

When determining the conformity between the rated input voltage and the rated output voltage (Yes in step S131), the determiner 102 compares the first current specification data included in the first electrical specification data with the second current specification data included in the second electrical specification data to determine whether the maximum output current is equal to or smaller than the rated input current (step S133).

Similarly to the above case, also in the example described below, the input-output unit is an input unit, and the input-output device is an output device. In this example, the first current specifications indicate the rated input current of the input unit, and the second current specifications indicate the maximum output current of the output device. The determiner 102 determines whether the maximum output current is equal to or smaller than the rated input current.

When determining the maximum output current to be greater than the rated input current (No in step S133), the determiner 102 determines the nonconformity in electrical specifications between the input-output unit and the input-output device (step S132), and ends the operation of conformity determination for electrical specifications.

When determining the maximum output current to be equal to or smaller than the rated input current (Yes in step S133), the determiner 102 determines the conformity in the electrical specifications between the input-output unit and the input-output device (step S134), and ends the operation of conformity determination for electrical specifications.

The above describes the setting assistance device 10 according to Embodiment 1. The setting assistance device 10 determines whether an input-output device is connectable to an input-output unit in accordance with the electrical specification data. Thus, the setting assistance device 10 appropriately assists in the connection setting between input-output units and input-output devices.

Embodiment 2

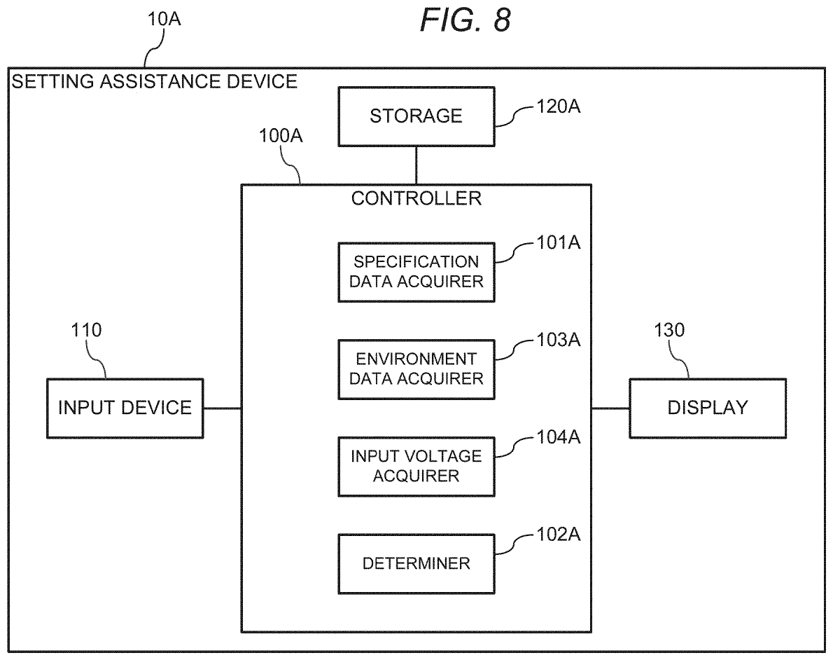

The setting assistance device 10A according to Embodiment 2, and in particular, the differences from the setting assistance device 10 according to Embodiment 1, will now be described with reference to FIG. 8. The setting assistance device 10A includes a controller 100A in place of the controller 100 and a storage 120A in place of the storage 120.

The overview of the setting assistance device 10A will now be provided. The setting assistance device 10A further performs connectivity determination based on electrical specifications associated with the input-output unit installation environment. The input-output unit installation environment refers to an environment in which the PLC is actually operated with the input-output unit installed.

More specifically, when the input-output unit is an input unit, the setting assistance device 10A performs connectivity determination in accordance with the specifications for the relationship between the ambient temperature, the input voltage, and the number of usable points of the input unit.

The number of points will be described first. The number of usable points is defined for an input-output unit. The number of use points is also defined for an input-output device. To connect input-output devices to an input-output unit, the total number of use points of the input-output devices is not allowed to exceed the number of usable points of the input-output unit. For example, when the number of usable points of an input-output unit is 16, the input-output unit may be connected with up to 16 input-output devices having the number of use points of 1. The input-output unit may also be connected with three input-output devices having the number of usable points of 5 and further one input-output device having the number of use points of 1. For ease of understanding hereafter, the number of use points of the input-output device is 1, unless otherwise specified.

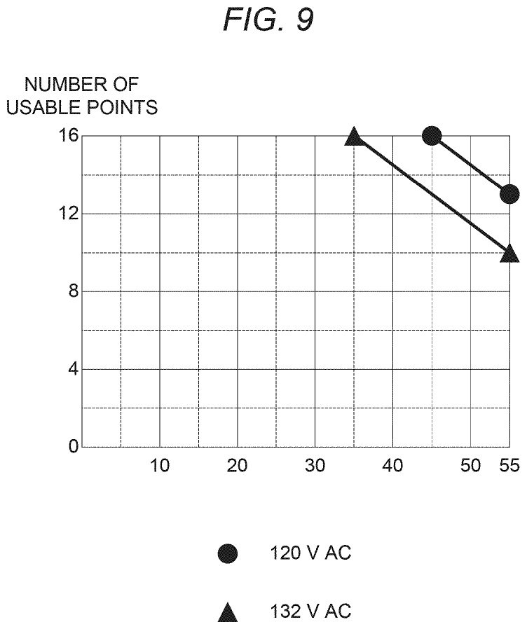

The relationship between the ambient temperature, the input voltage, and the number of usable points of the input unit will now be described with reference to an example shown in FIG. 9. FIG. 9 is a graph included in, for example, the specifications for the input unit. The number of usable points decreases as the ambient temperature increases. The number of usable points also decreases as the input voltage increases. In FIG. 9, for example, at the input voltage of 120 V and the ambient temperature of 45° C., the number of usable points is 16. At the input voltage of 132 V and the ambient temperature of 55° C., the number of usable points is 10. The number of usable points varies with the input voltage. The specifications for the relationship between the ambient temperature, the input voltage, and the number of usable points may thus be regarded as electrical specifications.

The above relationship is defined typically for an input-output unit that is an input unit, not for an input-output unit that is an output unit. In Embodiment 2, the input-output unit is an input unit, and the input-output devices are output devices, unless otherwise specified.

In the example in FIG. 9, the input unit assumes the highest rated input voltage to be 120 V. The reason that the input voltage of 132 V is shown even though the highest rated input voltage is 120 V is because common input units are operable at input voltages about 10% higher than the rated input voltages. Many input unit manufacturers thus have the specifications designed at the limit value of 132 V. In the example shown in FIG. 9, the input unit assumes the ambient temperature of not exceeding 55° C. but having the limit value of 55° C.

As described above, the setting assistance device 10A performs connectivity determination between the input unit and the output devices in accordance with the relationship between the ambient temperature, the input voltage, and the number of usable points shown in FIG. 9.

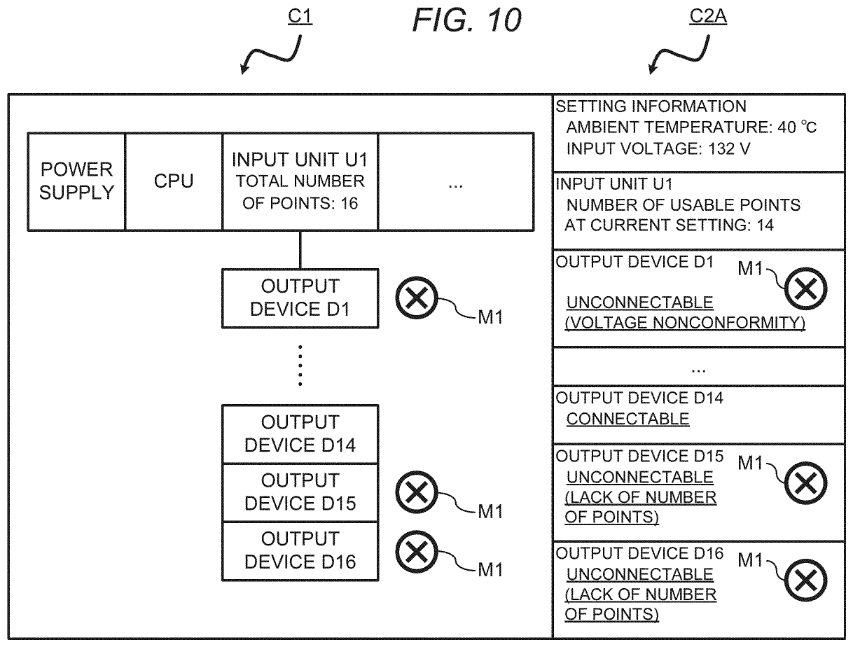

An example screen displayed by the setting assistance device 10A will now be described with reference to FIG. 10. The screen shown in FIG. 10 includes a configuration display area C1 and a data display area C2A. As in Embodiment 1, the configuration display area C1 is used for displaying the configuration of the PLC units and the input-output devices. Unlike in Embodiment 1, the total number of points is displayed in the field of the input unit. The total number of points refers to the total number of use points of input-output devices connected to the input unit.

The data display area C2A displays setting information, the number of usable points of the input unit at the current setting, information about whether the input-output device is connectable, and the like.

The setting information displayed in the data display area C2A is information indicating the ambient temperature and the input voltage of the input unit that are assumed when the PLC is actually operated. The ambient temperature and the input voltage are set by the user's input operations. For example, setting the input voltage at 132 V allows the setting assistance device 10A to perform connectivity determination for operations at the limit.

The number of usable points of the input unit displayed in the data display area C2A is a number of usable points at the ambient temperature and the input voltage indicated by the setting information. In the example in FIG. 10, the ambient temperature is set at 40° C. with the input voltage at 132 V, and thus the input unit has a number of usable points of 14, as shown in FIG. 9.

In the example in FIG. 10, the output device D1 is unconnectable to the input unit U1 due to voltage nonconformity as in Embodiment 1, although voltage specifications or current specifications are not displayed. This is because the setting assistance device 10A also performs determination for voltage specifications and current specifications similarly to the setting assistance device 10 according to Embodiment 1. The user may switch the display mode of the area to the voltage specifications and the current specifications by an operation performed on the data display area C2A. The details of the voltage nonconformity can be checked by switching the display.

In the example in FIG. 10, an output device D15 and an output device D16 are also unconnectable to the input unit U1 due to lack of the number of points.

The above provides the overview of the setting assistance device 10A. Referring back to FIG. 8, the functional components of the setting assistance device 10A different from the functional components of the setting assistance device 10 according to Embodiment 1 will be described.

The controller 100A includes a specification data acquirer 101A, an environment data acquirer 103A that acquires ambient temperature data, an input voltage acquirer 104A that acquires input voltage data, and a determiner 102A. In accordance with input information acquired from the input device 110, the controller 100A stores the ambient temperature data indicating the ambient temperature and the input voltage data indicating the input voltage into the storage 120A.

The specification data acquirer 101A has the functions described below, in addition to the functions of the specification data acquirer 101 according to Embodiment 1.

The specification data acquirer 101A acquires the first electrical specification data and also number-of-usable-points data indicating the relationship between the ambient temperature, the input voltage, and the number of usable points of the input unit illustrated in FIG. 9. As described in detail later, the number-of-usable-points data is included in an input-output unit table stored in the storage 120A. The number-of-usable-points data is included in the first electrical specification data. The number-of-usable-points data indicates the electrical specifications associated with the ambient temperature corresponding to an installation environment, and is thus an example of environment specification data according to the present disclosure.

The specification data acquirer 101A acquires the number-of-use-points data indicating the number of use points of the input-output devices from an input-output device table stored in the storage 120A.

The environment data acquirer 103A acquires ambient temperature data indicating the ambient temperature defined in the setting information from the storage 120A. The ambient temperature data indicates the input-output unit installation environment, and is thus an example of environment data according to the present disclosure. The environment data acquirer 103A is an example of environment data acquisition means according to the present disclosure.

The input voltage acquirer 104A acquires input voltage data indicating the input voltage defined in the setting information from the storage 120A. The input voltage acquirer 104A is an example of input voltage acquisition means according to the present disclosure.

The determiner 102A has the functions described below, in addition to the functions of the determiner 102 according to Embodiment 1.

The determiner 102A calculates the number of usable points of the input unit based on the number-of-usable-points data acquired by the specification data acquirer 101A, the ambient temperature data acquired by the environment data acquirer 103A, and the input voltage data acquired by the input voltage acquirer 104A. The relationship indicated by the number-of-usable-points data allows calculation of the number of usable points at the ambient temperature indicated by the ambient temperature data and the input voltage indicated by the input voltage data.

The determiner 102A determines whether the output devices are connectable to the input unit based on the calculated number of usable points and the number-of-use-points data acquired by the specification data acquirer 101A. The determination will be described in detail later.

The storage 120A stores the input-output unit table and the input-output device table similarly to the storage 120 according to Embodiment 1. However, the input-output unit table and the input-output device table each include data different from the corresponding data in Embodiment 1, as described later. The storage 120A also stores the ambient temperature data and the input voltage data.

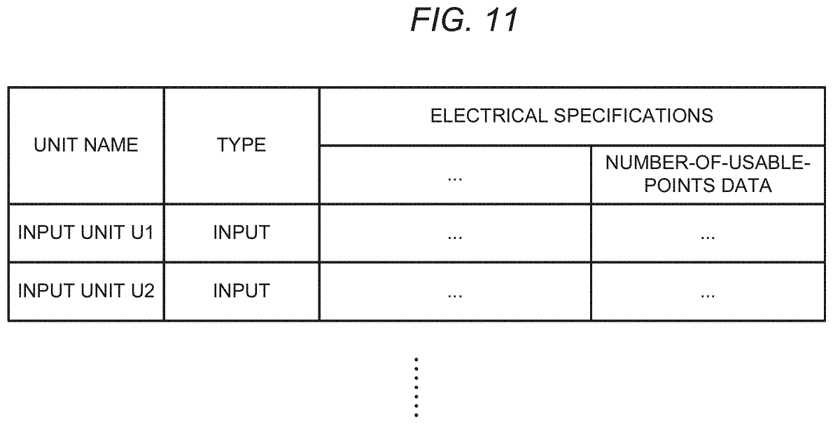

The input-output unit table stored in the storage 120A will now be described with reference to FIG. 11. The input-output unit table includes number-of-usable-points data as electrical specifications. In FIG. 11, the other electrical specifications are not shown. As described above, the number-of-usable-points data refers to data indicating the relationship between the ambient temperature, the input voltage, and the number of usable points of each input unit.

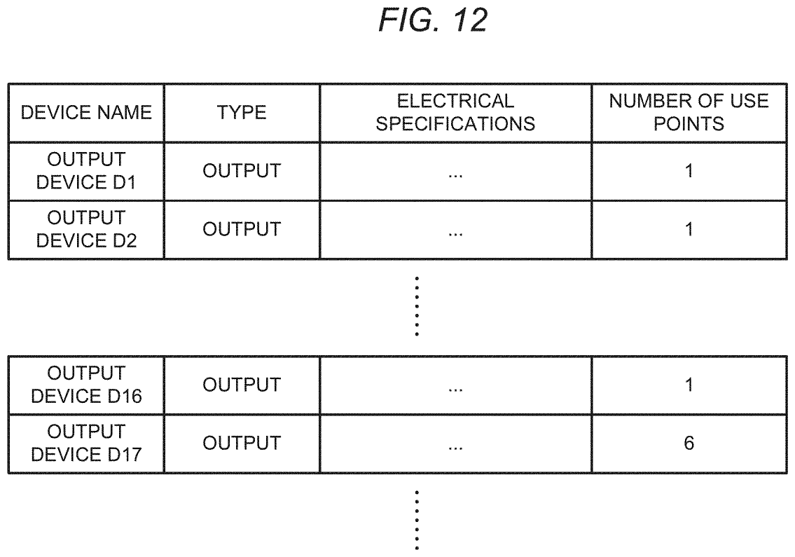

The input-output device table stored in the storage 120A will now be described with reference to FIG. 12. In FIG. 12, electrical specifications are not shown. The input-output device table includes data indicating the number of use points.

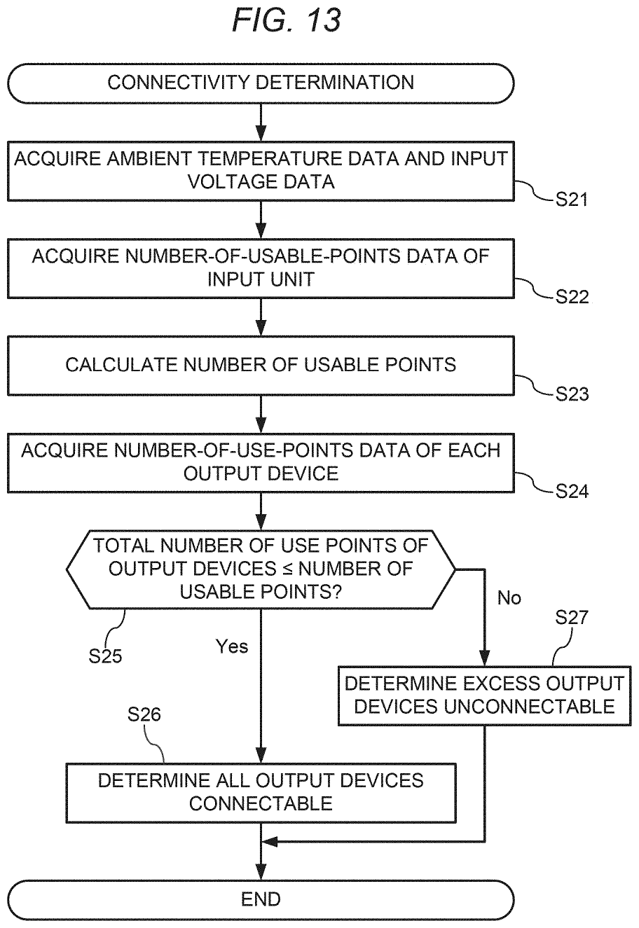

The above describes the functional structure of the setting assistance device 10A. An example operation of the connectivity determination performed by the setting assistance device 10A will now be described with reference to FIG. 13. The setting assistance device 10A performs the operation of connectivity determination shown in FIG. 13, as well as the operation of connectivity determination shown in FIG. 6 in the same manner as in Embodiment 1. These operations of connectivity determination may be performed in series or in parallel.

The environment data acquirer 103A in the controller 100A acquires the ambient temperature data, and the input voltage acquirer 104A in the controller 100A acquires the input voltage data (step S21). The specification data acquirer 101A in the controller 100A acquires the number-of-usable-points data of the input unit for which the connection setting is to be made (step S22).

The determiner 102A in the controller 100A calculates the number of usable points of the input unit based on the ambient temperature data, the input voltage data, and the number-of-usable-points data (step S23). The specification data acquirer 101A in the controller 100A acquires the number-of-use-points data of each output device for which the connection setting is to be made (step S24).

The determiner 102A calculates the total number of use points of the output devices based on the acquired number-of-use-points data, and determines whether the total number of use points is equal to or smaller than the number of usable points calculated in step S23 (step S25).

When determining the total number of use points to be equal to or smaller than the number of usable points (Yes in step S25), the determiner 102A determines all the output devices to be connectable to the input unit (step S26). The setting assistance device 10A then ends the operation of connectivity determination.

When determining the total number of use points to be greater than the number of usable points (No in step S25), the determiner 102A determines that all the excess connected output devices over the number of usable points are unconnectable to the input unit (step S27). The controller 100A then ends the operation of connectivity determination.

The above describes the example operation of the connectivity determination performed by the setting assistance device 10A. The operation in FIG. 13 and the operation in FIG. 6 may provide different determination results for the same output device. The determination as being unconnectable is then prioritized. For example, the output device D1 in the example in FIG. 10 is determined to be unconnectable in the operation in FIG. 6 but connectable in the operation in FIG. 13. In this case, the determination as being unconnectable is prioritized, and Unconnectable is displayed in FIG. 10.

The above describes the setting assistance device 10A according to Embodiment 2. The setting assistance device 10A determines whether input-output devices are connectable to an input-output unit based on the environment data and the environment specification data. Thus, the setting assistance device 10A appropriately assists in the connection setting between input-output units and input-output devices.

Embodiment 3

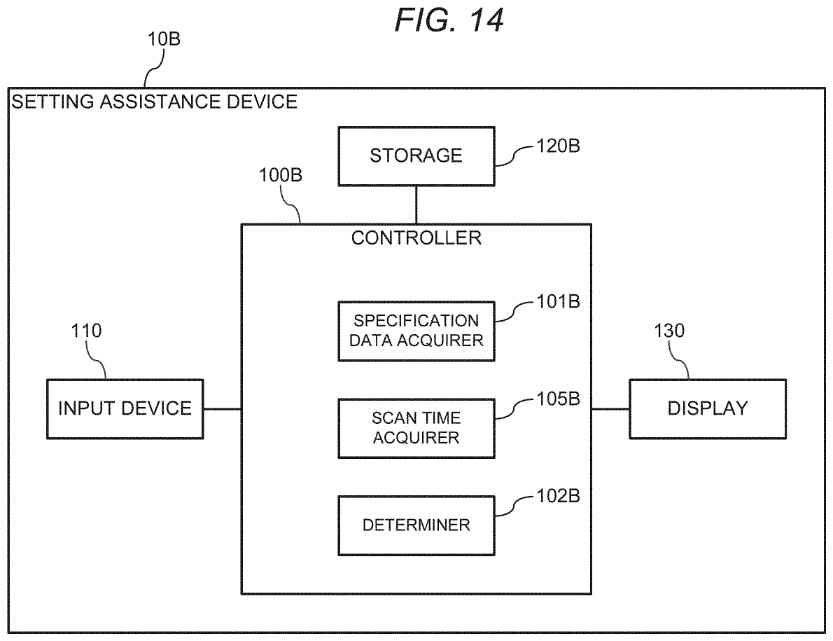

The setting assistance device 10B according to Embodiment 3, and in particular, the differences from the setting assistance device 10 according to Embodiment 1, will now be described with reference to FIG. 14. The setting assistance device 10B includes a controller 100B in place of the controller 100 and a storage 120B in place of the storage 120.

The overview of the setting assistance device 10B will now be provided. Based on scan time of a program executed on the PLC and the operating speed specifications of an input-output device, the setting assistance device 10B further determines whether the execution speed of the program conforms to the operating speed of the input-output device. The conformity between the execution speed of the program and the operating speed of the input-output device will be described later. The determination as to whether the execution speed of the program conforms to the operating speed of the input-output device will be simply referred to as operating speed conformity determination. The conformity or nonconformity between the execution speed of the program and the operating speed of the input-output device may be simply referred to as conformity or nonconformity in the operating speed of the input-output device.

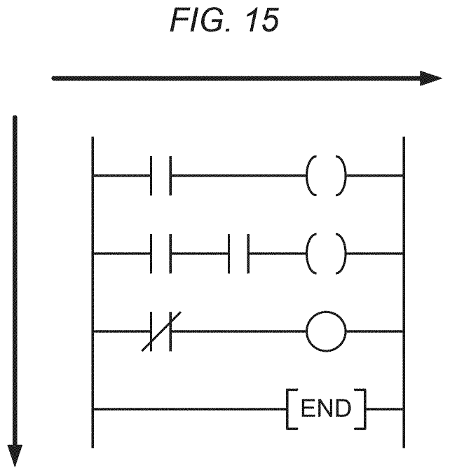

The scan time will be described with reference to FIG. 15. FIG. 15 is a ladder diagram showing a program that starts from an upper left position and is executed from left to right and top to bottom as indicated by arrows. When the program reaches the lower right position indicated by END, the process restarts from the upper left position. In the ladder diagram of FIG. 15, the time taken for the processing from the upper left to the lower right, END, is referred to as scan time. In other words, the scan time is the time taken for one cycle of program execution by the PLC. A larger program includes a longer scan time. As the CPU of a PLC has higher performance, the scan time is shorter. As the scan time is shorter, the execution speed of the program is higher.

The operating speed specifications will now be described. Typical examples of the operating speed specifications of an input-output device include the on-time and the off-time. The on-time of an input device refers to the time taken from when input signals change from off to on to when the input device detects the change. Similarly, the off-time of an input device refers to the time taken from when input signals change from on to off to when the input device detects the change.

The on-time of an output device refers to the time taken from when the determination to change output signals from off to on is made to when the output signals change from off to on. For example, for an output device that is a sensor, the on-time of the sensor is the time taken from when the sensor senses an object or an event to when the output signals are changed to on. Similarly, the off-time of the output device is the time taken from when the determination to change output signals from on to off is made to when the output signals changes from on to off

For an input-output device that changes signals rapidly, the signals may undergo changes from off, on, and to off during one cycle of program execution by the PLC. As a result, the PLC may perform processing without detecting a signal change. More specifically, the time taken for a signal to change from off, on, and to off may be shorter than scan time, causing a failure to detect a signal change. In addition, a failure to detect such a signal change may also occur for a signal change from on, off, and to on. The minimum time taken for a signal to change from off, on, and to off is the sum of the on-time and the off-time. The minimum time taken for a signal to change from on, off, and to on is also the sum of the on-time and the off-time. Without the possibility of a failure to detect a signal change, the execution speed of the program appears to conform to the operating speed of the input-output device. When detecting the possibility of a failure to detect a signal change based on the scan time and the operating speed specifications, the setting assistance device 10B determines the nonconformity between the execution speed of the program and the operating speed of the input-output device.

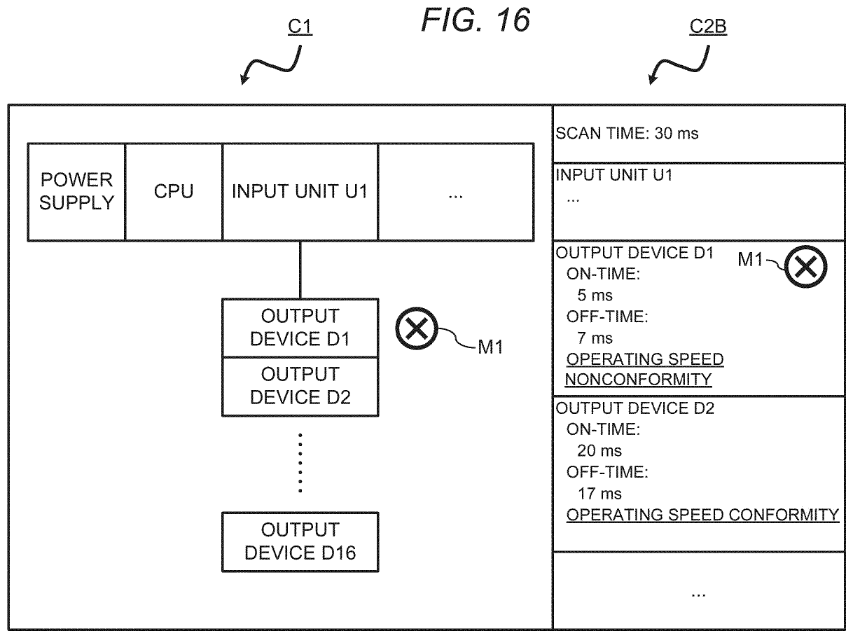

An example screen displayed by the setting assistance device 10B will now be described with reference to FIG. 16. The screen shown in FIG. 16 includes a configuration display area C1 and a data display area C2B. As in Embodiment 1, the configuration display area C1 is an area for displaying the configuration of the PLC units and the input-output devices. In the example in FIG. 16, the nonconformity is determined in the operating speed of the output device D1.

The data display area C2B displays scan time, input-output unit information, the operating speed specifications of an input-output device, and information indicating the conformability of the operating speed of the input-output device. Although no electrical specifications are displayed in the example in FIG. 16, the user may switch the display mode of the area to electrical specifications by performing an operation on the data display area C2B. Information about the electrical specifications can be checked by switching the display.

The above provides the overview of the setting assistance device 10B. Referring now back to FIG. 14, the functional structure of the setting assistance device 10B, and in particular, the differences from the setting assistance device 10 according to Embodiment 1, will be described.

The controller 100B includes a specification data acquirer 101B, a scan time acquirer 105B that acquires scan time, and a determiner 102B.

The specification data acquirer 101B has the functions described below, in addition to the functions of the specification data acquirer 101 according to Embodiment 1.

The specification data acquirer 101B acquires, from an input-output device table stored in the storage 120B, speed specification data indicating the operating speed specifications of the input-output device for which the connection setting is to be made. The input-output device table and the operating speed specifications will be described in detail later.

The speed specification data includes on-time data indicating the on-time of the input-output device and off-time data indicating the off-time of the input-output device.

The scan time acquirer 105B acquires scan time of a program executed on the PLC. The scan time acquirer 105B, for example, analyzes a program created on an engineering tool and calculates the scan time of the program to acquire the scan time. In some embodiments, the user may input scan time, and the scan time acquirer 105B may acquire the scan time based on the input information acquired from the input device 110. The scan time acquirer 105B is an example of scan time acquisition means according to the present disclosure.

The determiner 102B has the functions described below, in addition to the functions of the determiner 102 according to Embodiment 1.

The determiner 102B determines whether the execution speed of the program conforms to the operating speed of the input-output device based on the speed specification data and the scan time acquired by the scan time acquirer 105B. The determination will be described in detail later.

The storage 120B stores an input-output unit table and an input-output device table similarly to the storage 120 according to Embodiment 1. However, the input-output device table includes data different from the corresponding data in Embodiment 1, as described later.

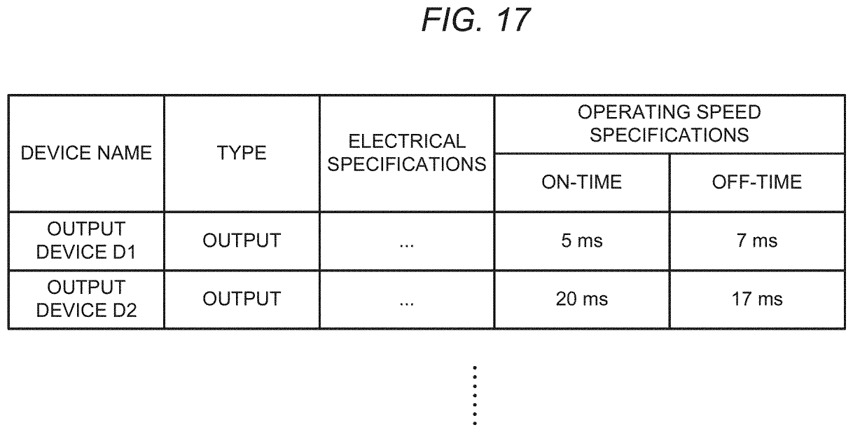

The input-output device table stored in the storage 120B will now be described with reference to FIG. 17. The input-output device table includes the operating speed specifications. In FIG. 17, electrical specifications are not shown. The operating speed specifications include an on-time and an off-time.

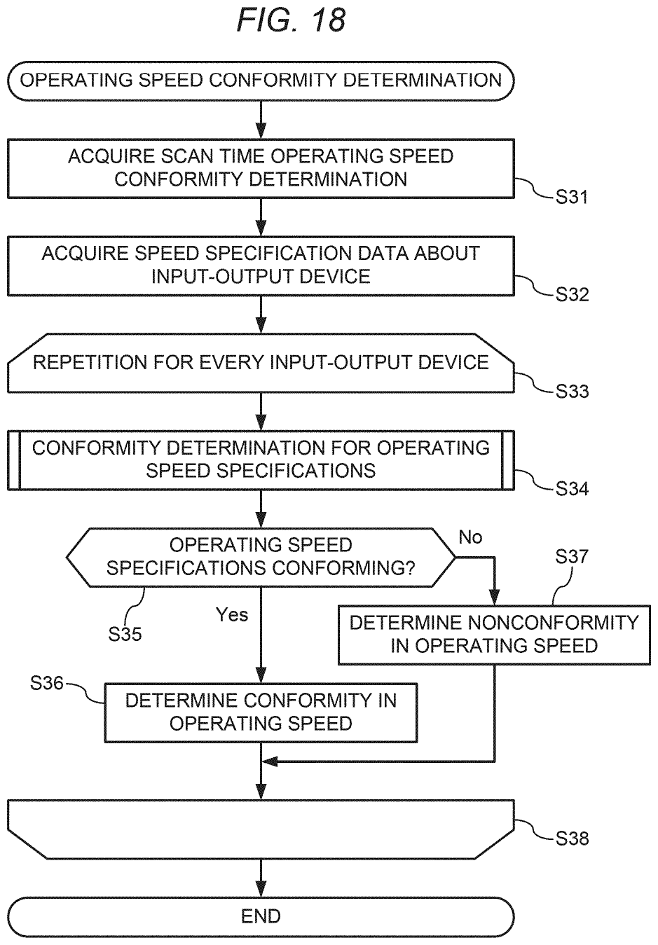

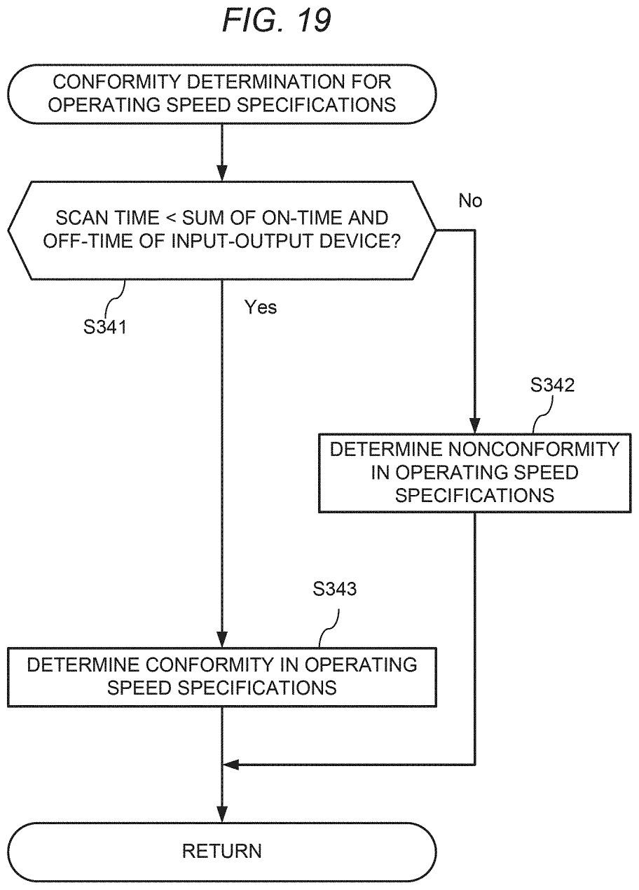

The above describes the functional structure of the setting assistance device 10B. An example operation of the operating speed conformity determination performed by the setting assistance device 10B will now be described with reference to FIGS. 18 and 19. The setting assistance device 10B performs the operation of operating speed conformity determination shown in FIG. 18, as well as the operation of connectivity determination shown in FIG. 6 in the same manner as in Embodiment 1. These determination operations may be performed in series or in parallel.

The scan time acquirer 105B in the controller 100B acquires scan time of a program executed on the PLC (step S31).

The specification data acquirer 101B in the controller 100B acquires the speed specification data of the input-output device for which the connection setting is to be made (step S32). With a plurality of input-output devices for which the connection setting is to be made, the specification data acquirer 101B will acquire the speed specification data about all the input-output devices.

The controller 100B selects one input-output device and performs the operation of steps S33 to S38, and repeats the process until completing the operation for every input-output device.

The determiner 102B in the controller 100B determines the conformability of the operating speed specifications of the selected input-output device (step S34). The conformity determination for operating speed specifications will be described in detail later.

When determining the conformity in the operating speed specifications (Yes in step S35), the determiner 102B determines the conformity in the operating speed of the selected input-output device (step S36). When determining the nonconformity in the operating speed specifications (No in step S35), the determiner 102B determines the nonconformity in the operating speed of the selected input-output device (step S37).

After the operation of steps S33 to S38 is performed for every input-output device, the controller 100B ends the operation of operating speed conformity determination.

The operation of conformity determination for operating speed specifications in step S34 will now be described with reference to FIG. 19. The determiner 102B first determines whether the scan time is shorter than the sum of the on-time of the input-output device indicated by the on-time data and the off-time of the input-output device indicated by the off-time data (step S341). The determiner 102B compares the scan time with the sum of the on-time and the off-time to determine whether the PLC may fail to detect a signal change.

When determining the scan time to be equal to or longer than the sum of the on-time and the off-time (No in step S341), the determiner 102B determines the nonconformity in the operating speed specifications of the input-output device (step S342), and ends the operation of conformity determination for operating speed specifications.

When determining the scan time to be shorter than the sum of the on-time and the off-time (Yes in step S341), the determiner 102B determines the conformity in the operating speed specifications of the input-output device (step S343), and ends the operation of conformity determination for operating speed specifications.

The above describes an example operation of the operating speed conformity determination performed by the setting assistance device 10B. In the example in FIG. 16, the determiner 102B determines the nonconformity in the operating speed of the output device D1 and the conformity in the operating speed of the output device D2. In response to the operating speed conformity determination by the determiner 102B, the controller 100B displays the nonconformity in the operating speed of the output device D1 and the conformity in the operating speed of the output device D2 on the screen.

The above describes the setting assistance device 10B according to Embodiment 3. The setting assistance device 10B determines whether execution speed of a program executed on the PLC conforms to the operating speed of an input-output device based on the scan time and the speed specification data. The setting assistance device 10B thus appropriately assists in the connection setting between input-output units and input-output devices.

Embodiment 4

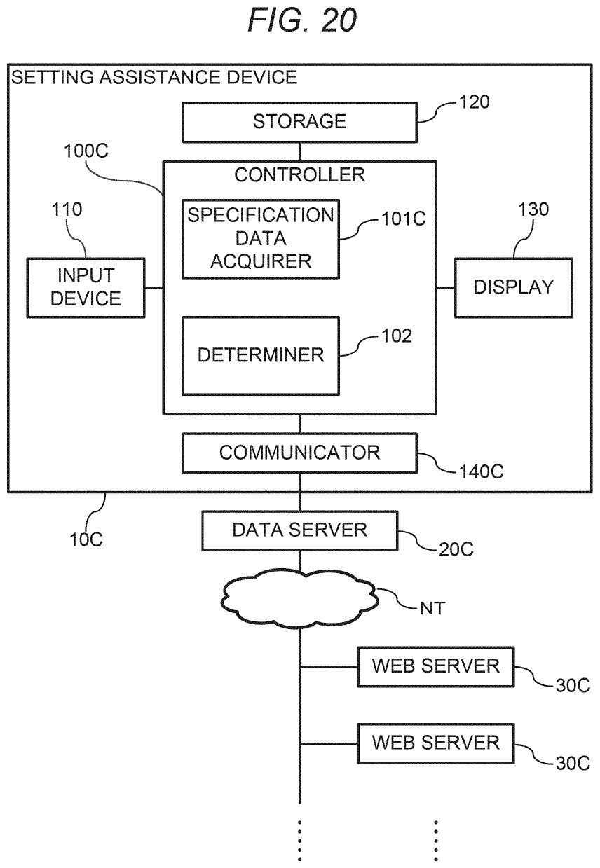

The setting assistance device 10C according to Embodiment 4, and in particular, the differences from the setting assistance device 10 according to Embodiment 1, will now be described with reference to FIG. 20. The setting assistance device 10C is connected with a data server 20C storing electrical specification data about input-output units and input-output devices. The setting assistance device 10C includes a controller 100C in place of the controller 100. The setting assistance device 10C also includes a communicator 140C that communicates with the data server 20C. The data server 20C communicates over the Internet NT with a web server 30C managed by the input-output unit manufacturer or the input-output device manufacturer.

The functional structure of the setting assistance device 10C, and in particular, the differences from the setting assistance device 10 according to Embodiment 1, will now be described. The controller 100C includes a specification data acquirer 101C in place of the specification data acquirer 101. The specification data acquirer 101C acquires electrical specification data about an input-output unit and an input-output device from the data server 20C via the communicator 140C. The specification data acquirer 101C stores the acquired electrical specification data about the input-output unit into an input-output unit table in the storage 120. The specification data acquirer 101C stores the acquired electrical specification data about the input-output device into an input-output device table in the storage 120.

The specification data acquirer 101C acquires electrical specification data from the data server 20C when, for example, electrical specification data about the input-output unit or the input-output device selected by the user is not found in the storage 120. For example, an output device D1 selected by the user as an input-output device for which the connection setting is to be made may be a new product, and thus the electrical specification data about the output device D1 is not included in the input-output device table in the storage 120. In this case, the specification data acquirer 101C acquires the electrical specification data about the output device D1 from the data server 20C. In some embodiments, the specification data acquirer 101C may acquire all electrical specification data sets from the data server 20C at regular intervals, and update the input-output unit table and the input-output device unit table in the storage 120.

However, the data server 20C may not contain the electrical specification data about the input-output unit or the input-output device selected by the user. As described later, the data server 20C may store information indicating the lack of the electrical specification data about the product. In these cases, the specification data acquirer 101C stores information indicating the absence of the electrical specification data about the input-output unit or the input-output device into the input-output unit table or the input-output device table.

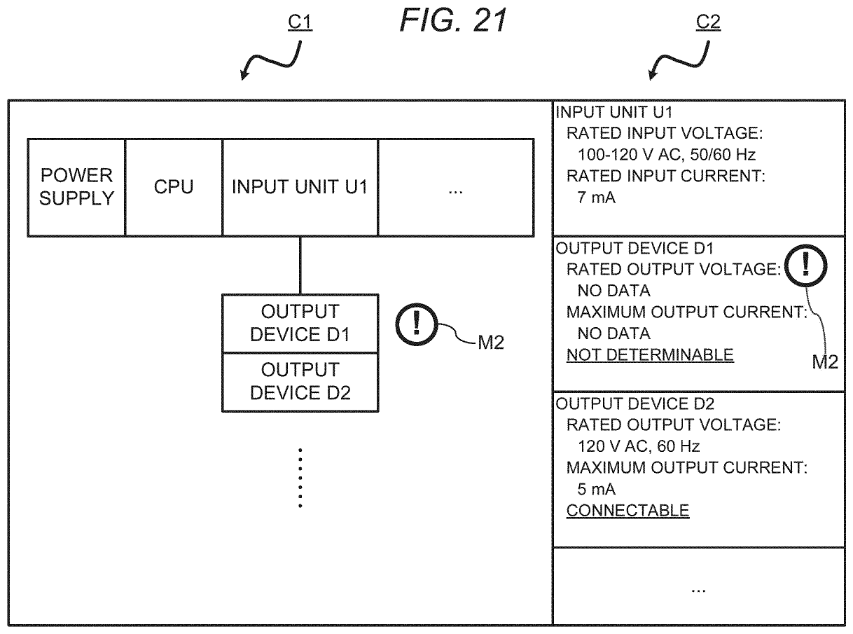

The controller 100C alerts the user through the display 130 to the absence of the electrical specification data about the input-output unit or the input-output device selected by the user and to the incapability of connectivity determination due to the absence of the electrical specification data. As shown in FIG. 21, for example, the controller 100C displays an attention mark M2 near the field of the output device D1 within the configuration display area C1 to alert the user to the incapability of connectivity determination. The controller 100C also displays information about the absence of the electrical specification data about the output device D1 and the incapability of connectivity determination in the data display area C2 to alert the user.

The alerted user may, for example, contact and ask the manager of the data server 20C to update the electrical specification data about the output device D1 manually.

The above describes the functional structure of the setting assistance device 10C. The operation of connectivity determination performed by the setting assistance device 10C is the same as in Embodiment 1 and will not be described repeatedly. The data server 20C and web servers 30C will now be described.

The data server 20C stores electrical specification data about input-output units and input-output devices. The data server 20C is, for example, a server managed by the engineering tool manufacturer. The data server 20C acquires the specification lists of products from the web servers 30C and updates the stored electrical specification data in accordance with the acquired specification lists. The products refer to input-output units or input-output devices manufactured by the managers of the web servers 30C. The data server 20C updates the electrical specification data at regular intervals such as every week or every month. In some embodiments, the data server 20C may update the electrical specification data when information about a new product is published on each web server 30C.

The web servers 30C are managed by input-output unit manufacturers or input-output device manufacturers. Different manufacturers manage different web servers 30C. The web servers 30C have the published specification lists of products.

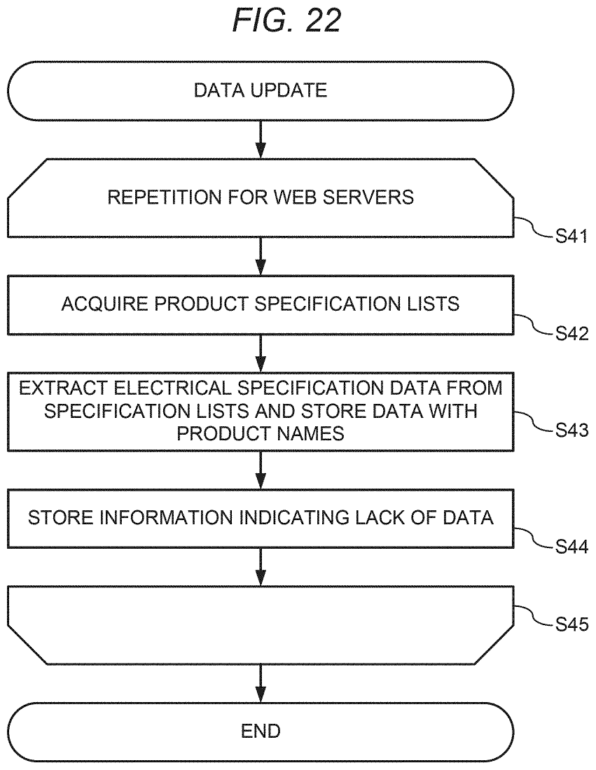

An example operation of the data update by the data server 20C will now be described with reference to FIG. 22. The data server 20C repeats the operation of steps S41 to S45 for every web server 30C from which specification lists are to be acquired.

The web servers 30C from which specification lists are to be acquired are, for example, web servers 30C managed by the manufacturers of products supported by the engineering tool.

The data server 20C acquires product specification lists from a web server 30C (step S42). The web server 30C has the published specification lists of a plurality of products, and the data server 20C acquires the specification lists of the products.

The data server 20C analyzes the contents of the acquired specification lists to extract electrical specification data, and stores the data in a manner associated with the product names (step S43). The formats of the specification lists seem to differ depending on the web server 30C. The data server 20C is thus to apply different analysis methods depending on the web server 30C. For example, a rated input voltage may be described as Rated Input Voltage: 100-120 V AC in one specification list and Rated Voltage (input): 100-120 V (alternating current) in another specification list. In this case, the data server 20C is to analyze the specification lists using different analysis methods. As a result of the analysis, electrical specification data indicating a rated input voltage of 100 to 120 V AC is extracted from each specification list.

The data server 20C may fail to acquire a product specification list available in the past due to the stopped production of the product or a failure in the web server 30C. The data server 20C may also fail to analyze a product specification list and cannot extract electrical specification data. These failures cause the lack of electrical specification data about the product. In this case, the data server 20C stores information indicating the lack of data about the product (step S44).

After the operation of steps S41 to S45 performed for every web server 30C from which specification lists are to be acquired, the data server 20C ends the operation of the data update.

The above describes the setting assistance device 10C according to Embodiment 4. The specification data acquirer 101C acquires electrical specification data from the data server 20C. The setting assistance device 10C thus performs connectivity determination based on the latest electrical specification data.

Modifications

The setting assistance device 10 according to Embodiment 1 performs connectivity determination based on the voltage specifications and the current specifications of electrical specifications. However, the setting assistance device 10 may perform connectivity determination based on other electrical specifications. For example, the electrical specifications of an input-output unit and an input-output device may include specifications about impedance, rush current, and noise resistance. The setting assistance device 10 may perform connectivity determination based on these electrical specifications.

The setting assistance device 10 according to Embodiment 1 performs connectivity determination based on both the voltage specifications and the current specifications. However, the setting assistance device 10 may perform connectivity determination based simply on the voltage specifications or the current specifications. For example, the engineering tool may be specialized in setting a specific system. The system may use input-output units and input-output devices with standardized voltage specifications. In this case, the setting assistance device 10 may perform connectivity determination based simply on the current specifications. Similarly, when the system clearly uses microcurrent alone, the setting assistance device 10 may perform connectivity determination based simply on the voltage specifications.

Although the setting assistance device 10A according to Embodiment 2 uses ambient temperature as the installation environment, other installation environments may also be used. Examples of installation environments other than ambient temperature include humidity, atmospheric pressure, gas concentration, and altitude. Among electronic components, the characteristics of capacitors are affected easily by the influence of these environments. Depending on the circuit configuration of an input-output unit, environment specifications may be defined based on changes in these installation environments. In this case, the setting assistance device 10A may perform connectivity determination based on the environment specifications and the installation environments.

The setting assistance device 10B according to Embodiment 3 performs operating speed conformity determination by comparing the scan time with the sum of the on-time and the off-time. In other words, the setting assistance device 10B performs operating speed conformity determination based on both the on-time and the off-time. However, the setting assistance device 10B may perform operating speed conformity determination based simply on the on-time or the off-time. For example, in place of the sum of the on-time and the off-time, the doubled on-time or the doubled off-time may be compared with the scan time to perform operating speed conformity determination. This is because an on-time and an off-time do not usually differ greatly from each other.

In Embodiment 4, the data server 20C extracts electrical specification data based on specification lists acquired from the web servers 30C and stores the data. However, electrical specification data to be stored into the data server 20C may be based on manual input. The data server 20C may not communicate with the web servers 30C. In this case, all electrical specification data sets are based on manual input.

In the hardware configuration shown in FIG. 5, the setting assistance device 10 includes the secondary storage 1004. However, the secondary storage 1004 may be installed external to the setting assistance device 10, and the setting assistance device 10 and the secondary storage 1004 may be connected to each other via the interface 1003. In this configuration, the secondary storage 1004 may be a removable medium such as a USB flash drive or a memory card.

In place of the hardware configuration shown in FIG. 5, the setting assistance device 10 may have a dedicated circuit including an application-specific integrated circuit (ASIC) or a field-programmable gate array (FPGA). In the hardware configuration shown in FIG. 5, some functions of the setting assistance device 10 may be implemented by, for example, a dedicated circuit connected to the interface 1003.

The program used in the setting assistance device 10 may be distributed on a non-transitory computer-readable recording medium such as a compact disc read-only memory (CD-ROM), a digital versatile disc (DVD), a USB flash drive, a memory card, or an HDD. A specific or a general-purpose computer on which the program is installed can function as the setting assistance device 10.

The program may be stored in a storage in another server on the Internet and may be downloaded from the server.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure is applicable to assistance in the connection setting between input-output units in a PLC and input-output devices.

### REFERENCE SIGNS LIST

10, 10A, 10B, 10C Setting assistance device

20C Data server

30C Web server

100, 100A, 100B, 100C Controller

101, 101A, 101B, 101C Specification data acquirer

102, 102A, 102B Determiner

103A Environment data acquirer

104A Input voltage acquirer

105B Scan time acquirer

110 Input device

120, 120A, 120B Storage

130 Display

140C Communicator

1000 Bus

1001 Processor

1002 Memory

1003 Interface

1004 Secondary storage

C1 Configuration display area

C2, C2A, C2B Data display area

M1 Error mark

M2 Attention mark

NT Internet

1. A setting assistance device for assisting in connection setting between an input-output unit in a programmable logic controller and an input-output device connectable to the input-output unit, the setting assistance device comprising:
an inputter to receive a user operation for selecting the input-output unit and the input-output device for which the connection setting is to be made;
a specification data acquirer to acquire first electrical specification data indicating electrical specifications of the input-output unit selected by the user through the inputter and second electrical specification data indicating electrical specifications of the input-output device selected by the user through the inputter; and
a determiner to determine, based on conformability between the electrical specifications indicated by the first electrical specification data and the electrical specifications indicated by the second electrical specification data, whether the input-output device is connectable to the input-output unit.

2. The setting assistance device according to claim 1, wherein
the first electrical specification data includes first voltage specification data indicating connection specifications about a voltage of the input-output unit,
the second electrical specification data includes second voltage specification data indicating connection specifications about a voltage of the input-output device, and
the determiner determines, based on conformability between voltage specifications indicated by the first voltage specification data and voltage specifications indicated by the second voltage specification data, whether the input-output device is connectable to the input-output unit.

3. The setting assistance device according to claim 1, wherein
the first electrical specification data includes first current specification data indicating connection specifications about a current of the input-output unit,
the second electrical specification data includes second current specification data indicating connection specifications about a current of the input-output device, and
the determiner determines, based on conformability between current specifications indicated by the first current specification data and current specifications indicated by the second current specification data, whether the input-output device is connectable to the input-output unit.

4. The setting assistance device according to claim 1, wherein
the specification data acquirer acquires at least one of the first electrical specification data or the second electrical specification data from a server.

5. The setting assistance device according to claim 1, further comprising:
an environment data acquirer to acquire environment data indicating an installation environment of the input-output unit,
wherein the first electrical specification data includes environment specification data indicating electrical specifications of the input-output unit associated with installation environment, and
the determiner further determines, based on the environment data and the environment specification data, whether the input-output device is connectable to the input-output unit.

6. The setting assistance device according to claim 5, further comprising:
an input voltage acquirer to acquire input voltage data indicating an input voltage input to the input-output unit,
wherein the environment data includes ambient temperature data indicating ambient temperature of the input-output unit,
the environment specification data includes number-of-usable-points data including ambient temperature, an input voltage, and the number of usable points of the input-output unit in a manner associated with one another,
the specification data acquirer further acquires number-of-use-points data indicating the number of use points of the input-output device, and
the determiner calculates the number of usable points based on the ambient temperature data, the input voltage data, and the number-of-usable-points data, and determines, based on the calculated number of usable points and the number-of-use-points data, whether the input-output device is connectable to the input-output unit.

7. The setting assistance device according to claim 1, further comprising:
a scan time acquirer to acquire scan time of a program executed by the programmable logic controller,
wherein the specification data acquirer further acquires speed specification data indicating operating speed specifications of the input-output device, and
the determiner further determines conformability between an execution speed of the program and an operating speed of the input-output device based on the scan time and the speed specification data.

8. The setting assistance device according to claim 7, wherein
the speed specification data includes on-time data indicating an on-time of the input-output device and off-time data indicating an off-time of the input-output device, and
the determiner determines conformability between the execution speed of the program and the operating speed of the input-output device based on the scan time, the on-time data, and the off-time data.

9. The setting assistance device according to claim 8, wherein
the determiner determines conformity between the execution speed of the program and the operating speed of the input-output device when a sum of the on-time and the off-time is equal to or longer than the scan time, and determines nonconformity between the execution speed of the program and the operating speed of the input-output device when the sum of the on-time and the off-time is shorter than the scan time.

10. A setting assistance method, comprising:
allowing a user selection of an input-output unit in a programmable logic controller and an input-output device connectable to the input-output unit for which connection setting is to be made;
acquiring first electrical specification data indicating electrical specifications of the input-output unit;
acquiring second electrical specification data indicating electrical specifications of the input-output device; and
determining, based on conformability between the electrical specifications indicated by the first electrical specification data and the electrical specifications indicated by the second electrical specification data, whether the input-output device is connectable to the input-output unit.

11. A non-transitory computer-readable recording medium storing a program causing a computer to perform operations comprising:
receiving a user operation for selecting an input-output unit in a programmable logic controller and an input-output device connectable to the input-output unit for which connection setting is to be made;
acquiring first electrical specification data indicating electrical specifications of the input-output unit;
acquiring second electrical specification data indicating electrical specifications of the input-output device; and
determining, based on conformability between the electrical specifications indicated by the first electrical specification data and the electrical specifications indicated by the second electrical specification data, whether the input-output device is connectable to the input-output unit.
